(19) United States
(12) Patent Application Publication
(10) Pub. No.: US 2017/0028429 A1
(43) Pub. Date: Feb. 2, 2017

(54) PROCESS & ASSEMBLY FOR FORMING A PLASTIC SKIN ON A 3D TEMPLATE SURFACE

(71) Applicant: STRUCTURAL PEELING PARTS, LLC, Auburn Hills, MI (US)

(72) Inventor: Miguel A. Linares, Auburn Hills, MI (US)

(21) Appl. No.: 15/224,295

(22) Filed: Jul. 29, 2016

Related U.S. Application Data
(60) Provisional application No. 62/199,780, filed on Jul. 31, 2015.

(51) Int. Cl. B05B 15/12

(52) U.S. Cl. CPC B05B 15/1207

(57) ABSTRACT

The present invention discloses an assembly for spray coating a plasticized skin onto a three dimensional template surface configured within a one piece template body. A transfer mechanism includes at least one gripping arm terminating in a body exhibiting a template surface. A first spray station applies a plastic skin coating to the template surface, with a second trimming operation to which the body is communicated in order to remove the plastic skin coating from the body and to finish the skin. The gripping arms are typically incorporated into a transfer mechanism further includes first and second pairs of telescoping arms extending in opposite directions from a rotatable turret, the body further including first and second bodies secured to extending ends of the pairs of arms.

### CROSS-REFERENCE TO RELATED APPLICATIONS

This Application claims the benefit of U.S. Provisional Application 62/199,780 filed on Jul. 31, 2015, the contents of which is incorporated herein in its entirety.

### FIELD OF THE INVENTION

The present invention discloses a process and assembly for spray coating a plasticized skin onto a three dimensional template surface configured within a one piece template body. A transfer mechanism including opposite extending gripping arms manipulates a pair of end configured template defining bodies in sequential fashion between a spray station and a curing/trimming operation, the plastic skin part then exiting via an outlet conveyor extending from the trimming operation following demounting from the 3D body.

### BACKGROUND OF THE INVENTION

The prior art is documented with examples of assemblies and methods for forming a plastic skin article. A first example of this is depicted in WO 2016/097654, entitled method for producing a decorative part of a motor vehicle, including the steps of spraying a product, with an area to be protected during spraying. Additional steps include applying a fluid material forming a temporary masking layer on the area to be protected, the step being carried out automatically, spraying the product onto the part and removing the temporary masking layer.

Linares, U.S. 2006/0131773, teaches an apparatus and method for making plastic molded articles generally having a double-skinned configuration with a foamed interior extending between the two skins. Various inserts can be placed within the foamed interior between the two skins, The apparatus includes the machinery used in order to make such a plastic article. The heated mold configurations can be made of inexpensive aluminum.

Finally Grimmer, U.S. Pat. No. 7,550,103, teaches an apparatus and method of producing plastic articles including preheating a metal mold having a mold contour using infrared heating elements formed to match the mold contour to establish a casting temperature. Additional steps include casting plastic material onto the preheated metal mold surfaces, fusing the plastic using infrared energy, cooling the metal mold using the change of phase or state of a cooling material and removing the cast plastic article from the metal mold.

### SUMMARY OF THE INVENTION

The present invention discloses an assembly for spray coating a plasticized skin onto a three dimensional template surface configured within a one piece template body. A transfer mechanism includes at least one gripping arm terminating in a body exhibiting a template surface. A first spray station applies a plastic skin coating to the template surface, with a second trimming operation to which the body is communicated in order to remove the plastic skin coating from the body and to finish the skin. The gripping arms are typically incorporated into a transfer mechanism further includes first and second pairs of telescoping arms extending in opposite directions from a rotatable turret, the body further including first and second bodies secured to extending ends of the pairs of arms.

Other features include the first spray station incorporating an overspray catch basin within which the body is positioned. A sheet material extending across a base of the bin for capturing plastic overspray. A pair of unwind and rewind spool rolls are supported along opposite sides of the bin and pass through slots formed in the bin for communicating the sheet material across the base of the bin. The sheet material can further include a heavy paperboard. The spray station further includes an articulating spray robot to which is communicated a pair of iso and poly flowable plastic materials for intermixing prior to application to each body.

The trimming operation further incorporates a curing sub-operation for drying the previously sprayed skin, as well as an overhead and vertically displaceable platen, an underside projecting retrieval frame including a plurality of suction elements for removing the skin from the template surface defined body. A stationary structure receives the plastic skin from the retrieval frame, an outlet ramp extending from the structure for delivering the skin to a proximately located exit conveyor.

Other features include the template surface defined body further incorporating a material not limited to an aluminum or wood. A mold maintenance and repair station is located proximate said stationary structure. A plurality of filtration elements extend about the inner perimeter of the basin and which is located proximate a bottom of the basin. Yet additional features include vacuum inducing components integrated into the basin in proximity to the filtration elements and operable in order to draw downwardly into the bin any liquids, solid particulates, fumes and the like through the filtration elements for evacuation through an air exhaust extending from an end of the basin.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective illustration of a robotic spray arm and overspray catch basin utilized in combination with a first end extending template body associated with an associated transfer mechanism;

FIG. 1A is a similar illustration to FIG. 1 and which shows a bottom and inner perimeter extending filtration exhaust incorporated into the overspray bin;

FIG. 2 is a curing/trimming operation to which a previously sprayed part upon a template surface is communicated by the transfer mechanism;

FIG. 3 illustrates an outlet conveyor for receiving a finished skin dismounted from the template body, following the curing/trimming operation;

FIG. 4 is an operational view of a plurality of individual plastic skin forming assemblies arranged in perimeter surrounding fashion around a main iso/poly plastic infeed station according to one non-limiting example;

FIG. 5 is an enlarged view of a single skin forming assembly depicted in the example of FIG. 4 and showing a flashing removal station associated with the curing/trimming operation;

FIG. 6 is a succeeding illustration to FIG. 5 depicting the spray coat and transfer assembly in an intermediate delivery position to the curing/trimming operation;

FIG. 7 illustrates a further intermediate delivery position to that shown in FIG. 6 and better showing the telescoping extension/retraction capabilities of the opposite extending gripping arms of the transfer mechanism for successively spray coating and transferring the plastic skin article to the curing/trimming operation; and

FIG. 8 is a further succeeding illustration of the assembly repeating the position of FIG. 1 to initiate the spray coating of a plastic article upon the one piece template defining body extended within the spray area with overspray catch basin.

### DETAILED DESCRIPTION OF THE PREFERRED EMBODIMENTS

The present invention discloses a process and assembly for spray coating a plasticized skin onto a three dimensional template surface configured upon a body, such as which is supported in extensible/retractable and rotary traversable fashion upon a numerically controlled transfer mechanism or robot. As will be further described, the numerically controlled transfer mechanism exhibits opposite extending gripping arms, to which are secured a pair of the 3D template defining bodies, each capable of exhibiting either of an identical or (if desired) varied template defining surface it is desired to produce parts of alternating configuration. In operation, the transfer mechanism manipulates the pair of end configured bodies in sequential fashion between an initial spray station and a succeeding curing/trimming operation, the plastic part exiting via an outlet conveyor extending from the trimming operation after being demounted (such as by peeling away) from the selected body.

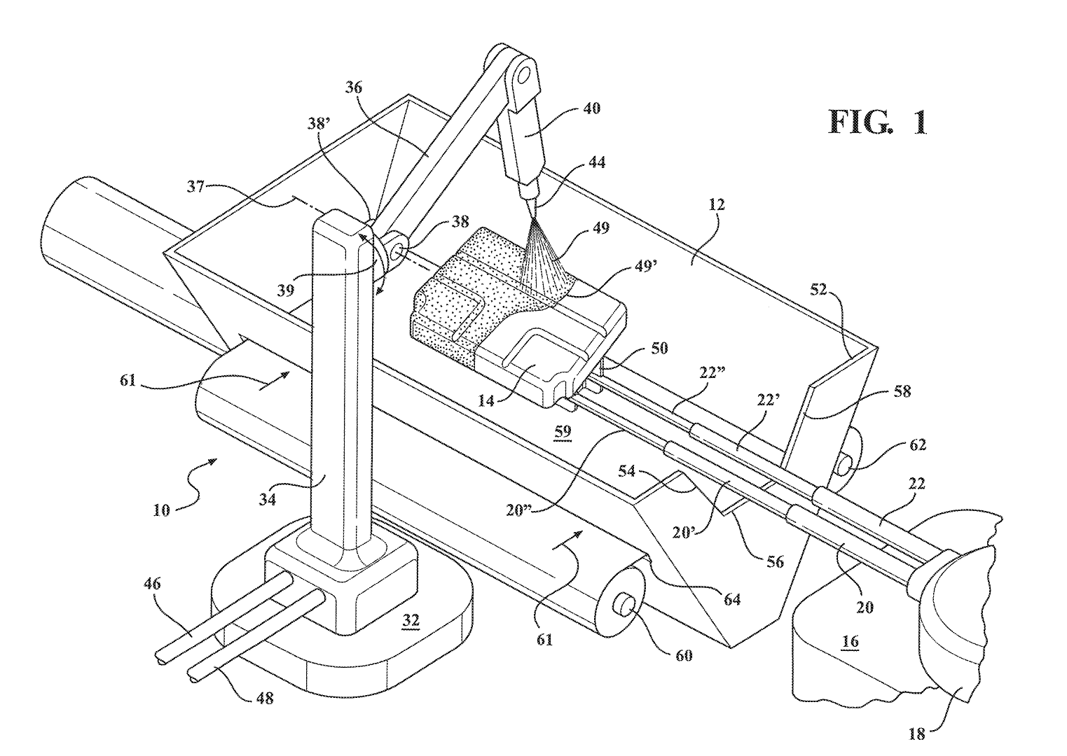

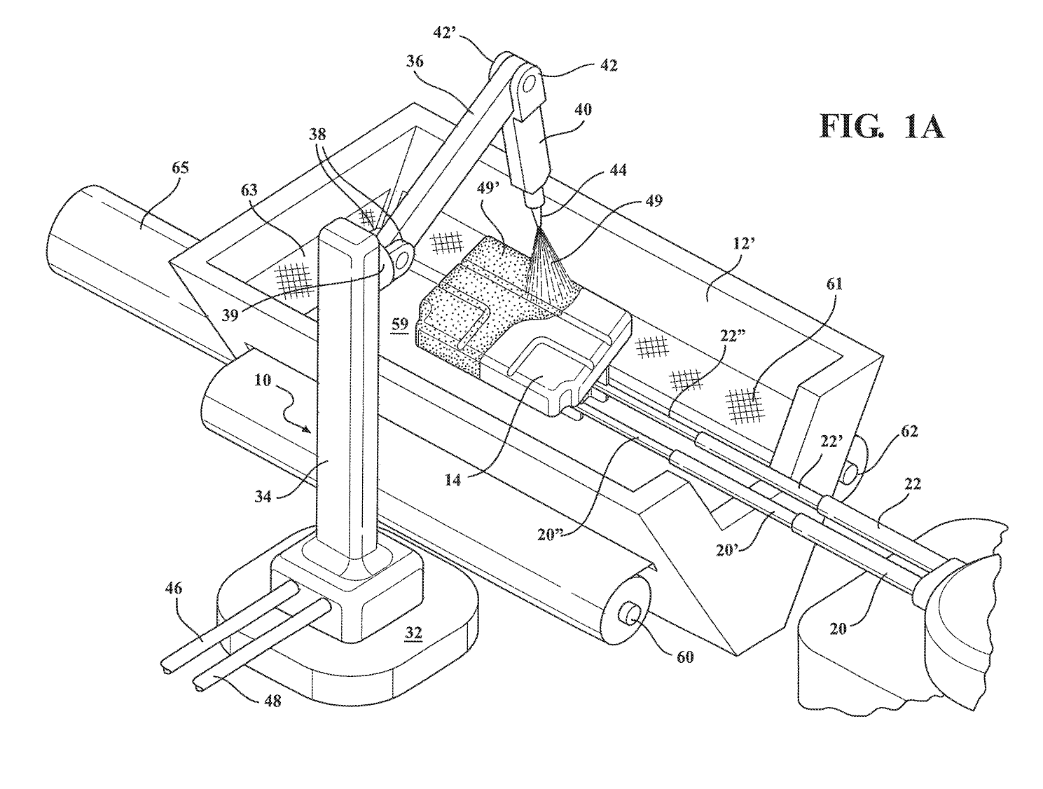

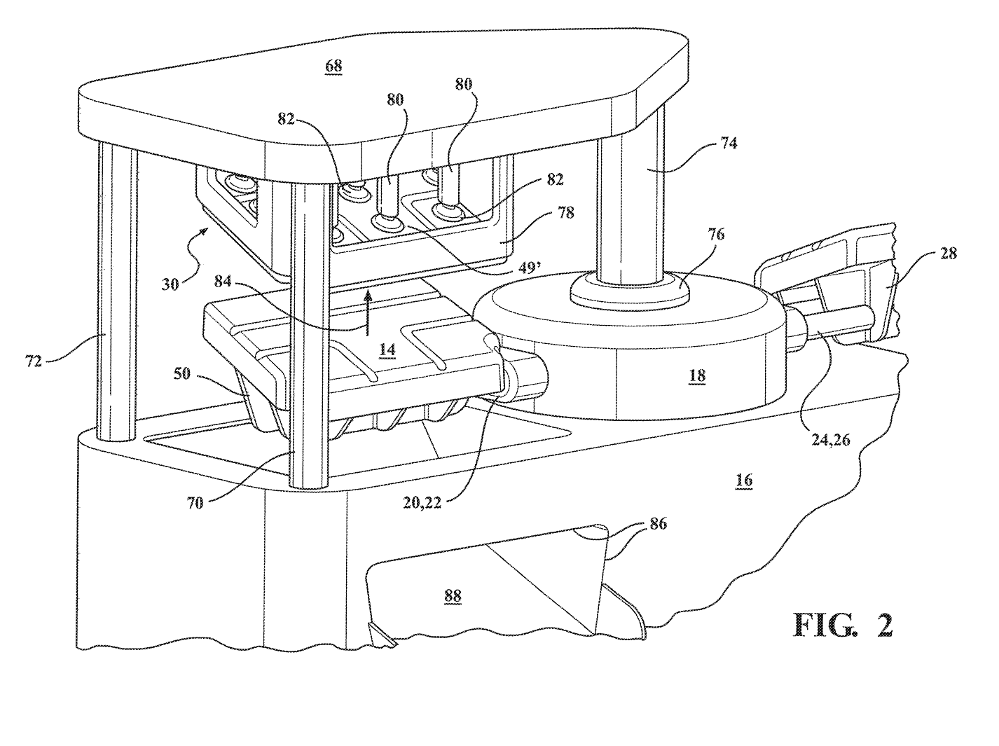

Referring first to FIG. 1, illustrated is a perspective illustration of a robotic spray arm 10 and overspray catch basin 12 utilized in combination with a selected first end extending body with 3D template defining surface 14 associated with the associated transfer mechanism. The transfer mechanism is further designated by a structure 16 (typically stationary however can be movable in certain installations), and upon which is rotatably supported a turret 18 and from which extends, in opposite directions, first 20/22 and second 24/26 pairs of telescoping arms, these again in turn support each of the template surface defined body 14 and an additional opposite end extending template defining body 28 (see as shown in FIG. 2). Although not shown, the transfer mechanism is operated by a suitable numerical controller which includes the successive steps of extending and retracting the pairs 20/22 and 24/26 of telescoping arms in a timed sequential fashion in order to progressively extend and retract the opposite end extending 3D template defining bodies 14 and 28 between the spray basin 12 and a subsequent curing/trimming station (see as shown at 30 in FIG. 2) which can be incorporated into the stationary structure 16 upon which the transfer mechanism turret 18 is supported.

The robotic spray arm (generally again at 10 in FIG. 1) includes a pedestal base 32 with a fixed upright extending body. An articulating spray arm includes a first arm 36 pivotally connected along a first articulating axis 37 defined between a pair of spaced apart flanges, lobes or supports 38/38′, these in turn mounted to a rotating collar 39 for enabling concurrent articulation and rotation of the arm in the manner depicted.

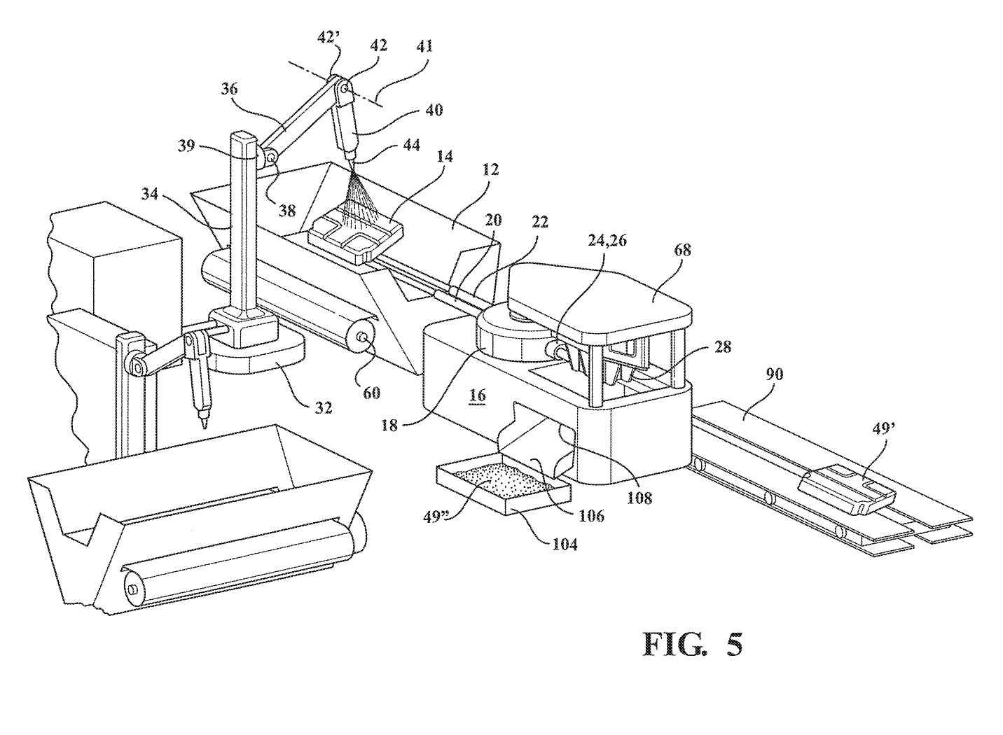

A second arm 40 extends from a further pivotal connection (see at 41 along with spaced apart supports 42/42′ in FIG. 5) to provide a combination of two pivoting axes along with a separate rotational axis. A spray nozzle 44 extends from an end of the second arm 40 and, via one or more conduits extending either inside or alongside the spray robot base, body and articulating arms, delivers a plasticized spray material to the 3D template surface of the body 14.

As further shown in FIG. 1, a pair of first 46 and second 48 conduit lines are illustrated communicating with the base of the spray robot 10 (and as is understood being in communication with the internal or external conduits extending therein or there-along). The input conduits 46/48 can, without limitation, include any type of iso and/or poly plastic or composite plastic material, such as which is reduced to a liquid form and is delivered in a continuous spray and built up fashion upon the configured template surface of the 3D body 14. The spray material may also include without limitation any other chemical recipes/mixtures (such as including setting agent ingredients, chemical catalysts or other fast setting/drying components) capable of establishing a desired built-up thickness upon the template surfaces and corresponding to a desired kin-type part.

Non-limiting examples of the plastic spray coating (see at 49 in FIG. 1) can include any of a polyurea, polyurethane or other structural spray material, including both commercially known or trade secret formulations for creating the desired skin thickness part (see further as applied onto the template surface at 49′) having a desired degree of flexibility and structural integrity. Without limitation, any flowable plasticized material, such as including that generally described above, can be sprayed or applied in any other non-limiting fashion.

The plasticized material can also include any suitable composition not limited to any known blends in a liquid state and settable polymer. The plasticized coating can further include an aggregate or other non-liquid entrained particulate or other component, such as which is intermixed with the liquid base structure of the coating and subsequently applied with a high pressure sprayer or the like. Without limitation, the present invention further contemplates the substitution of any proprietary or trade secure composition to further enhance the operational properties of the article thus coated.

The three dimensional and exterior template or pattern defining bodies (again at 14 and 28) can further be constructed of any material not limited to a metal (e.g. aluminum). It is also envisioned that the template defining bodies can further include a one piece wood or other cellulosic or ceramic based or faced material, such including the desired surface configuration and profile for producing the desired spray thickness plastic arid peel away part. The template bodies may also be heated as part of the spray coat, thickness buildup of the desired skin-type part and as part of the curing and trimming operations.

As again shown in FIG. 1, the template body 14 is depicted as supported within an open volumetric space. As further shown, an underside projecting support 50 of the template body 14 is engaged by end most extending portions 20″/22″ (see also intermediate portions 20′/22′) of the telescoping arms (FIG. 2 again showing the opposite extending pairs of telescoping arms 24, 26 extending to the second template defining body 28 and as shown in a retracted position).

As illustrated in each of FIGS. 1-2, the catch basin 12 further exhibits a four sided and outwardly flared side wall construction with an upper perimeter edge 52, with an end proximate the extending arms 20/22 further exhibiting a notched profile (see interconnecting edges 54/56/58 communicating with the upper perimeter edge 52) and through which is extended and retracted the pairs of telescoping anus and template defining 3D bodies as shown in FIG. 1. A waste paper roll 59 includes a first unwinding spool 60 (see arrows 61/61′) and a second take-up spool 62.

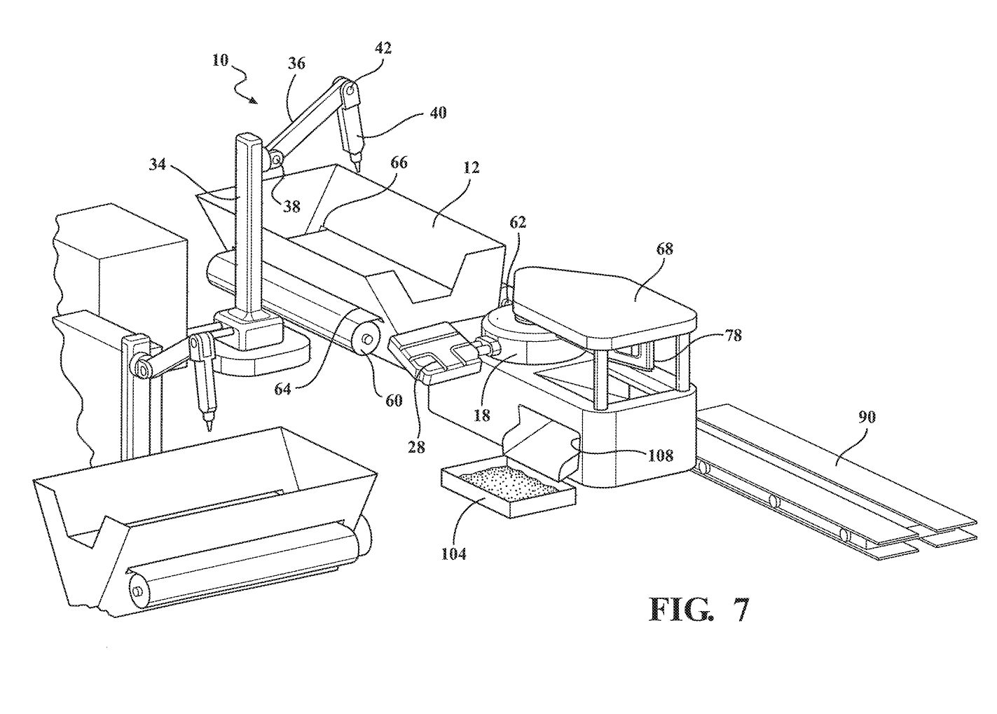

The paper roll 59 is constructed of such as a heavy duty paper material or the like and which extends through slots (see at 64 and further at 66 in FIG. 7) defined in the length extending sides of the bin 12 and so that the paper material extends across the base interior of the overspray bin 12 underneath the extended template body 14/28. In practice, the roll 59 is advanced in iterations following a number of spray application cycles of the template bodies 14/28 extended overhead within the open interior of the basin 12, and during which the currently advanced section of the paper 59 extending across the bin base interior accumulates a plastic overspray resulting from the build-up skin thickness coatings applied to the template surfaced bodies. Following a determined buildup of plastic overspray (such as which typically dries and sets to the exposed surface area of the paper), the bin interior extending (coated) paper section is then advance to the take up roll 62 and, upon complete winding of the paper on the take up roll, it can be removed from (or along with) the rewinding spool and discarded or forwarded for recycling, this concurrent with installing a new roll on the unwinding spool 60 and running the the outermost edge to the take up roll 62.

FIG. 1A is a similar illustration to FIG. 1 and which shows a bottom and inner perimeter extending filtration exhaust incorporated into a modification 12′ of the overspray basin. This includes a plurality of filtration elements (two of which are shown at 61 and 63) extending about the inner perimeter of a modification of the basin and which is located proximate the bottom of the bin and the inner extending direction of the overspray paper collection roll 59. In one non-limiting application, a plurality of four such filtration elements are positioned about the inside facing interior of the four sided bin 12′.

Although not shown, a series of vacuum inducing components (including fan generated reverse airflow elements) are integrated into the basin, such as in proximity to the filtration elements or which can be integrated into the separate air exhaust depicted at 65 extending from an end of the basin 12′. In operation, the vacuum exhaust capabilities of the basin draw downwardly within the basin interior any liquids, solid particulates, fumes and the like (such as emanating from the plastic spray nozzle or originating from the environment within which the assembly is set). The fumes, solids and/or particulates are then evacuated through the air exhaust 65 for filtering/venting/disposal.

Proceeding to FIG. 2, the curing/trimming operation 30 is depicted to which a previously plastic sprayed and built up template (14 in FIG. 1) is communicated by the rotation of the turret 18 of the transfer mechanism. The stationary structure 16 in the illustrated (and non-limiting) embodiment further includes an elevated platen 68 which is supported in vertically displaceable fashion above the structure via a pair of secondary support cylinders 70/72 at one end of the platen and a further main cylinder 74 at an opposite narrowed end of the platen which coincides with an annular fixed collar 76 about which mailed (inter-rotatably supported) the turret 18.

As further shown, an underside of the platen includes a retrieval frame 78 corresponding generally to a two-dimensional surface outline of the spray part 49′. A plurality of part removal/retention elements are provided and include underside projecting stems 80 along with end disposed suction cups 82 such that, and upon the numerical cont associated with the transfer mechanism (such being the same as or operating in timed fashion with the NC controller operating the spray robot 10) transferring the previously plastic spray coated template 14 in rotary fashion from the spray bin (station) 12 to the transfer mechanism 30 such that the retrieval frame is lowered along with the platen 68 so that the suction cups 82 align with and engage the surface locations of the template spray plastic part 49′.

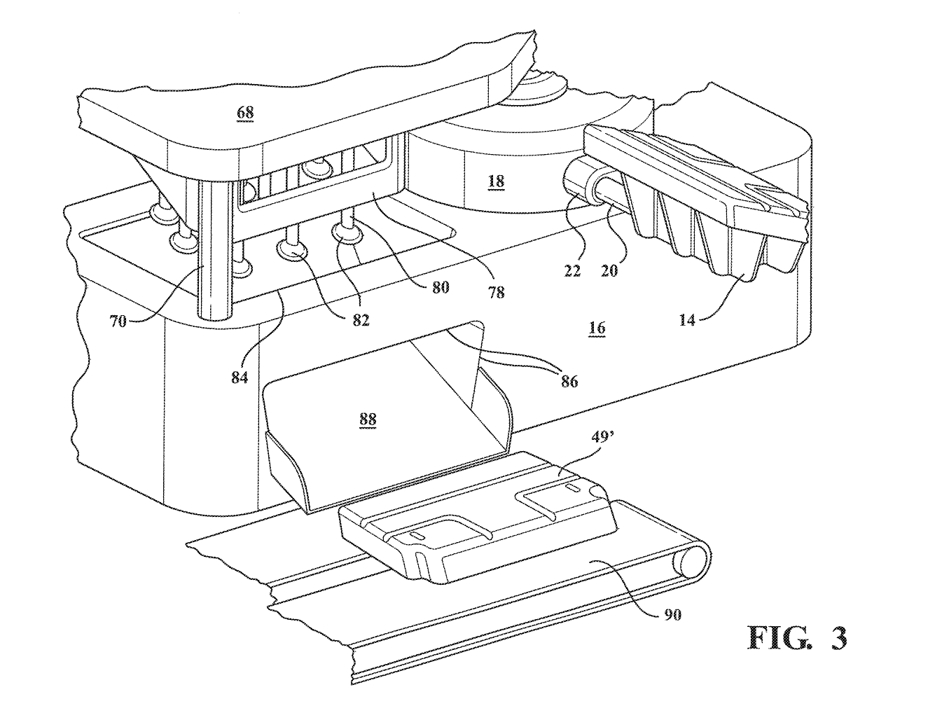

Upon gripping the skin thickness and spray coated (set or hardened) part 49′, the platen 68 is reverse displaced upwardly in the direction of arrow 84 (again FIG. 2), causing the plastic coated part 49′ to be peeled away from the template surface of the one piece forming or body 14/28. At this point, the transfer mechanism is further actuated (see FIG. 3) to rotatably displace the template body 14 out of alignment with the overhead supported retrieval frame and suction elements. The suction elements are further configured with a suction/vacuum release mechanism (such including a positive air pressure which can be communicated to the suction interface between the cup and the engaged surface of the part 49′), this resulting in the removed part being dropped through an opening (see rectangular shaped and upwardly facing closed perimeter 84) configured in the upper surface of the structure 16 over which the platen 68 is suspended.

In one application, the underside of the platen can incorporate a plurality of knife edges to facilitate trimming of part flashing during the down-stroke and prior to the reverse-upward stroke and removal of the part 49′ from the template 14. It is also envisioned that the structure 16 can also incorporate any type of heated curing or part flashing trimming operations in order to finish the plastic skin part 49′ and prior to the finished skin article exiting the structure 16 via a side disposed exit (see further interconnected perimeter defining surfaces 86 configured in the side of the structure 16 and revealing a ramp 88 leading to a removal conveyor 90, such as further taking the finished part 49′ to shipping or the like). Although not disclosed in detail, the interior components of the curing/trimming operation can include any combination of interior heat curing or other finishing operations, such also contemplating aperture/hole forming of the plastic skin articles 49′ prior to them exiting via the conveyor 90 (FIG. 3).

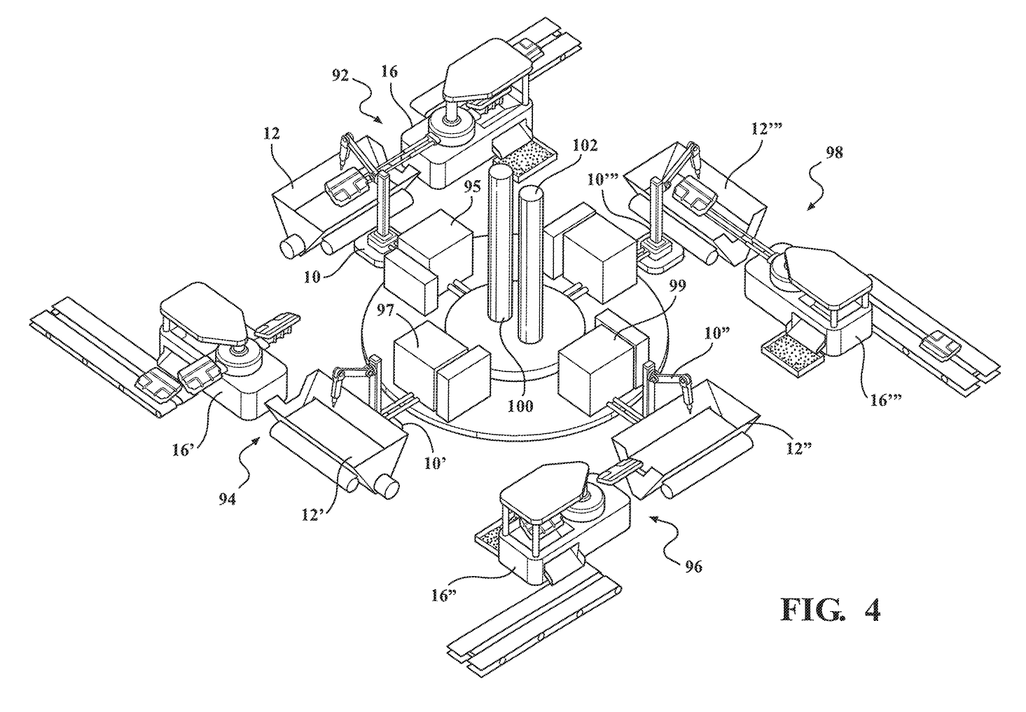

FIG. 4 is an operational view of a plurality of individual plastic skin forming assemblies, see at 92, 94, 96 and 98, which are arranged in perimeter surrounding fashion around a main iso/poly plastic infeed station input conduits 100 and 102) which lead to sub-set mixing stations 95, 97, 99 and 101 associated with the individual forming assemblies 92, 94, 96 and 98, respectively, according to one non-limiting example. As further shown, the arrangement of spray robots 10, 10′, 10″, and 10′″, are arranged in perimeter spaced fashion around the main iso poly input conduits, with the two part plastic material being fed to the individual fee lines again at 46 and 48 in FIG. 1) associated with each numerically controlled spray robot.

Additional features include a matching plurality of part removal structures 16, 16′, 16″ and 16′″ configured in proximity to associated spray bins 12, 12′, 12″ and 12′″ associated with each of the individual assemblies 92, 94, 96 and 98. Beyond that shown, and plurality of spray production lines can be configured in use with common iso/poly input or feed lines 100 and 102. Otherwise, the system operates in essentially the same fashion as described in FIGS. 1-3 and it is further understood that spray production can be accomplished with one production line or multiple lines arranged in any fashion not limited to that shown.

FIG. 5 is an enlarged view of a single skin forming assembly depicted in the example of FIG. 4 (from a reverse angle) and showing a flashing removal station associated with the curing/trimming operation. This in particular includes a bin 104 positioned at a bottom of a further ramp 106 extending through a further perimeter 108 defined opening (opposite the opening 86 and ramp 88 of in FIG. 3) for collecting the plastic bits and flashing (identified at 49″) sectioned from the finished part 49′, such being subsequently forwarded for recycling or disposal.

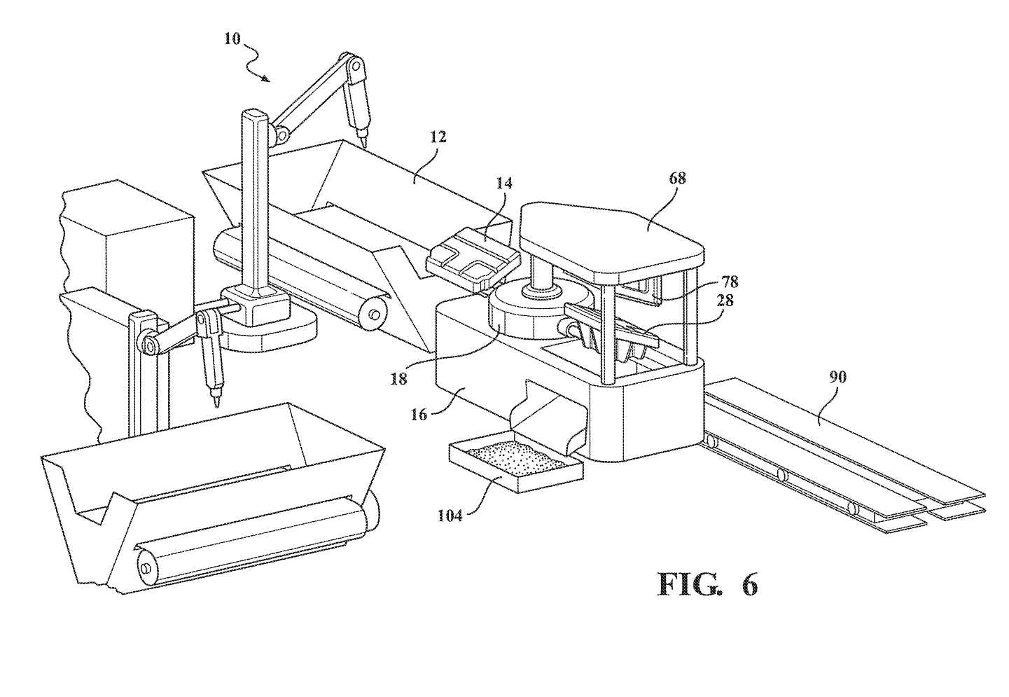

FIG. 6 is a succeeding illustration to FIG. 5 depicting the spray coat and transfer assembly in an intermediate delivery position to the curing/trimming operation, with FIG. 7 illustrating a further intermediate delivery position to that shown in FIG. 6 and better showing the telescoping extension/retraction capabilities of the opposite extending gripping arms of the transfer mechanism for successively spray coating and transferring the plastic skin article to the curing/trimming operation, such as through a succession of 180° rotations of the turret 18 in order to iteratively displace the template forming surfaces of the bodies/molds 14 and 28 between the spray bins 12 and the curing/trimming operations 30.

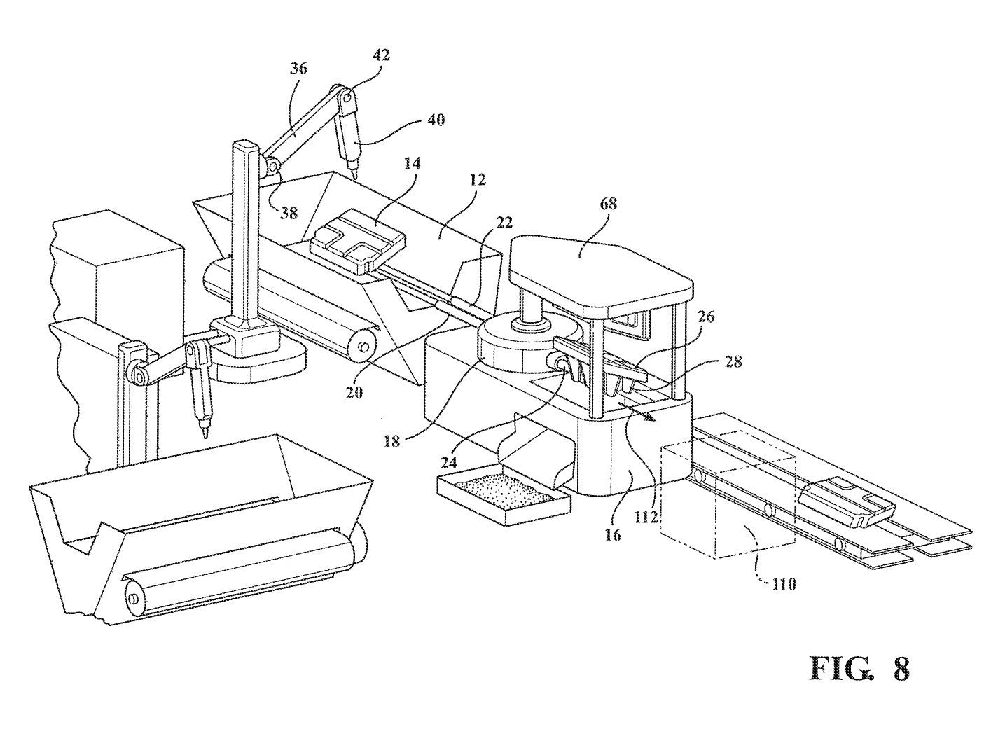

Finally, FIG. 8 is a further succeeding illustration of the assembly repeating the position of FIG. 1 to initiate the spray coating of a plastic article upon the one piece template defined body 14 extended within the spray area with overspray catch basin 12, with the opposite end extending body 28 arranged within the trimming operation 30 prior to being accessed by the part retrieval frame with suction elements. Also shown is an adjacent structure 110 located astride the main structure which can be designated for mold maintenance and repair. It is further envisioned that the given set of arms (see at 24/26) can be employed to extend the mold body 28 to the repair area 110 (see directional arrow 112).

Having described my invention, other and additional preferred embodiments will become apparent to those skilled in the art to which it pertains and without deviating from the scope of the appended claims:

I claim:

1. An assembly for spray coating a plasticized skin onto a three dimensional template surface configured within a one piece template body, comprising:
a transfer mechanism including at least one gripping arm terminating in a body exhibiting a template surface;
a spray station for applying a plastic skin coating to said template surface; and
a trimming operation to which said body is communicated in order to remove the plastic skin coating from said body and to finish the skin.

2. The invention as described in claim 1, said transfer mechanism further comprising first and second pairs of telescoping arms extending in opposite directions from a rotatable turret, said body further including first and second bodies secured to extending ends of said pairs of arms.

3. The invention as described in claim 1, said spray station further comprising an overspray catch basin within which said body is positioned.

4. The invention as described in claim 3, further comprising a sheet material extending across a base of said bin for capturing plastic overspray.

5. The invention as described in claim 4, further comprising a pair of unwind and rewind spool rolls supported along opposite sides of said bin and passing through slots formed in said bin for communicating said sheet material across said base of said bin.

6. The invention as described in claim 5, said sheet material further comprising a heavy paperboard.

7. The invention as described in claim 3, said spray station further comprising an articulating spray robot to which is communicated a pair of iso and poly flowable plastic materials for intermixing prior to application to each body.

8. The invention as described in claim 1, said trimming operation further comprising a curing sub-operation for drying the previously sprayed skin.

9. The invention as described in claim 1, said trimming operation further comprising an overhead and vertically displaceable platen, an underside projecting retrieval frame including a plurality of suction elements for removing the skin from said template surface defined body.

10. The invention as described in claim 9, said trimming operation further comprising a stationary structure receiving the plastic skin from said retrieval frame, an outlet ramp extending from said structure for delivering the skin to a proximately located exit conveyor.

11. The invention as described in claim 1, said template surface defined body further comprising a material not limited to an aluminum or wood.

12. The invention as described in claim 10, further comprising a mold maintenance and repair station located proximate said stationary structure.

13. The invention as described in claim 3, further comprising a plurality of filtration elements extending about the inner perimeter of said basin and which is located proximate a bottom of said basin.

14. The invention as described in claim 13, further comprising vacuum inducing components integrated into said basin in proximity to the filtration elements and operable in order to draw downwardly into the bin any liquids, solid particulates, fumes and the like through said filtration elements for evacuation through an air exhaust extending from an end of said basin.

15. An assembly for spray coating a plasticized skin onto a three dimensional template surface configured within a one piece template body, comprising:
a transfer mechanism including at least one gripping arm terminating in a body exhibiting a template surface;
a spray station for applying a plastic skin coating to said template surface; and
a trimming operation to which said body is communicated in order to remove the plastic skin coating from said body and to finish the skin, said trimming operation further including an overhead and vertically displaceable platen, an underside projecting retrieval frame including a plurality of suction elements for removing the skin from said template surface defined body.

16. The invention as described in claim 15, said trimming operation further comprising a stationary structure for receiving the plastic skin from said retrieval frame, an outlet ramp extending from said structure for delivering the skin to a proximately located exit conveyor.

17. The invention as described in claim 15, further comprising a mold maintenance and repair station located proximate said stationary structure.

18. An assembly for spray coating a plasticized skin onto a three dimensional template surface configured within a one piece template body, comprising:
a transfer mechanism including at least one gripping arm terminating in a body exhibiting a template surface;
a spray station for applying a plastic skin coating to said template surface;
said spray station further including an overspray catch basin within which said body is positioned, a sheet material extending across a base of said bin for capturing plastic overspray; and
a trimming operation to which said body is communicated in order to remove the plastic skin coating from said body and to finish the skin.

19. The invention as described in claim 18, said spray station further comprising an articulating spray robot to which is communicated a pair of iso and poly flowable plastic materials for intermixing prior to application to each body.

20. The invention as described in claim 18, said trimming operation further comprising a curing sub-operation for drying the previously sprayed skin.
